(19) United States
(12) Patent Application Publication
(10) Pub. No.: US 2012/0323586 A1
(43) Pub. Date: Dec. 20, 2012

(54) SYSTEM AND METHOD FOR AUTOMATED GEMSTONE PRE-CERTIFICATES

(76) Inventor: Ofer Davidov, New York, NY (US)

(21) Appl. No.: 13/164,393

(22) Filed: Jun. 20, 2011

(51) Int. Cl. G06F 17/30; G06Q 30/00

(52) U.S. Cl. 705/1.1; 707/769; 707/E17.014

(57) ABSTRACT

A system and method for providing authentication information associated with a gemstone. At least one database stores electronic gemstone information and electronic certificate information for a plurality of gemstones. First electronic gemstone information representing a first determination of at least one characteristic of a first gemstone is received from a merchant. A pre-certificate that represents at least some of the characteristics of the gemstone is generated and provided to the merchant. Second electronic gemstone information associated with a final certificate is received and an accuracy of the first determination is made by comparing the second determination with the first determination. A notification is transmitted to the first computing device that represents the accuracy.

### BACKGROUND

1. Field

The present application relates, generally, to rating gemstones and, more particularly, to an automated system and method for providing pre-certification of diamonds and other jewels.

2. Description of the Related Art

Buyers of rare jewels, such as diamonds, require detailed knowledge of the attributes of a particular stone, such as size, color, clarity, etc., and that those attributes are accurately represented by a merchant. Thus, buyers demand proof of, for example, the gemstone's size, color, clarity grade, and cut grade, in the form of a third party authentication certificate.

In the prior art, authorities of gemstones, such as the GEMOLOGICAL INSTITUTE OF AMERICA, certify gemstones as to these attributes and quality. By providing objective determination and analysis of the attributes of gemstones, consumers are protected from potential abuse and misrepresentation by merchants.

Obtaining an official certification for gemstones is expensive and time consuming. Nonetheless, although a consumer may be interested in a particular gemstone, he or she will balk at purchasing or even considering purchase if a certification of the gemstone is not provided. Accordingly, merchants must bear the costs associated with obtaining a certification for gemstones to satisfy consumers. This results in a reduction of advertised inventory of available gemstones for sale, as well as increased costs to merchants.

Recognizing the above, it has been established in the industry to obtain less rigorously reviewed, so-called “pre-certificates”. These are prepared by certification institutes at lower cost. Nonetheless, even at lower cost, a merchant who wishes to advertise hundreds or thousands of different gemstones might incur substantial costs and processing delays, which results in a reduced inventory of advertised gemstones available to the public.

### SUMMARY

Accordingly, it is object of the present invention to provide to merchants a service that generates gemstone pre-certificates at no cost.

It is a further object of the invention to provide to merchants a system that allows generation of pre-certificates with a minimal effort and at great speed, and which does not require time delays for a third party to generate such pre-certificates through manual processes.

It is a further object of the invention to provide a system that is available via the Worldwide Web, and is accessible on-line and which allows merchants to procure pre-certificates for gemstones at great speed and at no cost.

The foregoing and other objects of the invention are realized with a system and method that comprises: storing, on one or more processor readable media that are operatively coupled to one or more processors, at least one database comprising: i) electronic gemstone information received from a plurality of merchants and including information representing a plurality of respective gemstones; ii) electronic certificate information representing certificates of at least some of the plurality of respective gemstones; receiving, by the one or more processors from a first computing device operated by a first merchant over a communication network, first electronic gemstone information representing a first determination of at least one characteristic of a first gemstone; generating, by the one or more processors using at least some of the first electronic gemstone information, a pre-certificate that represents at least some of the characteristics of the gemstone; providing, to the first computing device, the pre-certificate; receiving, by the one or more processors, second electronic gemstone information associated with a final certificate that represents a second determination of the at least one characteristic of the gemstone; determining an accuracy of the first determination by comparing the second determination with the first determination; and transmitting a notification to the first computing device representing the accuracy. The first electronic gemstone information represents at least one of shape, weight, color grade, fancy color, clarity grade, cut grade, polish, symmetry, fluorescence, girdle, culet, table, crown angle, crown height, pavilion angle and pavilion depth.

Features and advantages of the present application will become apparent from the following description of the invention that refers to the accompanying drawings.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIG. 1 is an example user log-in display screen in accordance with an embodiment;

FIG. 2 is an example display screen provided to an authorized user for creating and accessing gemstone pre-certificates in accordance with an embodiment;

FIG. 3 illustrates an example data entry display screen that is provided when a registered merchant works to create a new gemstone pre-certificate in accordance with an embodiment;

FIG. 3A shows an example display screen in which a data entry options section of FIG. 3 has been eliminated in accordance with an embodiment;

FIG. 4 illustrates data entry options provided with information that were submitted by a registered merchant in accordance with an embodiment;

FIG. 5 illustrates an example gemstone pre-certificate generated and displayed in accordance with an embodiment;

FIG. 6 is a flowchart illustrating steps associated with generating a gemstone pre-certificate in accordance with an embodiment; and

FIG. 7 illustrates an example flowchart that includes steps associated with determining the accuracy of a respective gemstone pre-certificate and reliability of a merchant.

### DESCRIPTION OF EMBODIMENTS

The present application provides for instant and cost free, pre-certification of gemstones that is based on guidelines and policies that merchants follow in accordance with the terms and conditions of the pre-certificate issuing body. The pre-certificate system and method in accordance with the teachings herein defers the need for merchants to obtain and pay for a full gemstone certificate having a corporate seal signature of a gemologist.

By providing pre-certification of gemstones in accordance with the teachings herein, significant financial savings will be enjoyed by merchants. In accordance with the present application, the cost associated with certificates is required only for gemstones that are actually sold or are pending sale. Thus, merchants are not required to purchase and pay for pre-certificates for every gemstone in their available inventory. Moreover, consumers can rely on the relative accuracy identified in a pre-certificate when shopping for gemstones.

In an embodiment, a merchant applies for and is awarded a pre-certificate for a gemstone, and an image of the pre-certificate is generated and made available for the merchant. The image of the pre-certificate may be used in templates and/or any internet websites where gemstones, such as diamonds, are shown or sold. This eliminates delays and backlog associated with obtaining a pre-certificate.

Unlike prior art gemstone pre-certificates that may cost thirty dollars or so per pre-certificate, in a preferred embodiment, pre-certification for gemstones are provided for merchants at no cost. In exchange for providing free gemstone pre-certificates, merchants commit to ordering full certificates as needed from the provider of the pre-certificate. For example, a merchant orders a pre-certificate for a gemstone. Thereafter, the merchant sells the gemstone, and orders a full certificate from the provider of the pre-certificate. Thus, to qualify for the pre-certification program of the present application and become a registered merchant, merchants are contractually obligated to order full certificates for each stone sold having a pre-certificate from the pre-certificate provider. In this way, a revenue source is assured.

In preferred embodiments, criteria are defined for merchants to follow when ordering a gemstone pre-certificate. Merchants preferably use generally accepted grading techniques. Gemstone characteristics are determined, for example, using a millimeter gage, master comparison stones, ultra-violet (“UV”) lamp, 10× loupe or binocular, microscope and carat scale. Thereafter, the user submits information relating to shape, weight, and cut, and also enters quality information, such as the quality of the polish, symmetry and cut grade. Moreover, the user submits information regarding the quality of the particular gemstone, such as relating to color, clarity and inclusions, which further serve to characterize the respective gemstone's size and quality.

In order to ensure accuracy and reliability of information submitted by merchants, safeguards are provided to ensure that the pre-certificate is at least within a range of the final certificate. In one embodiment, an onerous burden is placed on merchants to be honest and not overestimate the quality of a particular gemstone. Merchants may have an interest in providing conservative quality estimates in order to avoid exaggerating the size and quality of a particular stone. Prior to being awarded a pre-certificate, merchants are required to submit a declaration that all information provided in accordance therewith is true and accurate. The merchant has a vested interest in the integrity of information provided in accordance with the present application, for example, to avoid being terminated from the program and losing the opportunity to obtain gemstone pre-certifications.

Also, unlike prior art certification programs, the pre-certificate program of the present application is useable to obtain pre-certificates for gemstones that are mounted in jewelry, such as rings, earrings, necklaces and bracelets. This is because, for example, the merchants who sell the respective gemstones have access to the mounted stones and can submit the various information according to the predefined criteria for the pre-certificates. There is no requirement that a gemstone be removed from a piece of jewelry and provided to a third party for pre-certification.

In one or more embodiments, information submitted by a merchant with regard to obtaining a gemstone pre-certificate is weighted and compared to information received in connection with a final valuation certificate, such as from a recognized gemological laboratory. Differences in pre-certificate submissions and the final certificate are calculated and applied to a cumulative score that represents a discrepancy between the values submitted for the pre-certificate and the values submitted in the actual final certificate. If the difference is too high, the merchant may have its registration and privileges with the pre-certificate issuing service revoked.

In an embodiment, merchants are required to remain within a total and cumulative variance to ensure continued access and use of the system of the present invention. Merchants that are outside the variance may lose rights to the system and pre-certificates, in general. For example, a comparison of the value submitted by a merchant representing the clarity of a particular diamond and the value of the clarity set forth in the final certificate may merit a weighted value of 0.25. Continuing with this example, a comparison of the value submitted by the merchant for the color of the diamond and information representing the color of the diamond in the final certificate may merit a value of 1.25. Cumulatively, the merchant's pre-certificate value is 1.5, which may be insufficient for continued participation in the program.

In another alternative, each pre-certificate is assigned a value, such as five points, and each time a discrepancy between the pre-certificate value and the final certificate value of a respective entry is determined, a deduction off of the base value is applied. For example, the aggregate value of the differences between a gemstone pre-certificate equals 1.75. The 1.75 aggregate value is deducted from the base 5.0 base value, leaving a final value of 3.25. In this alternative embodiment, another pre-determined value, such as 3.0, may be applied as the lowest acceptable value. In this example, since 3.25 is higher than 3.0, the pre-certificate would be deemed within an acceptable tolerance.

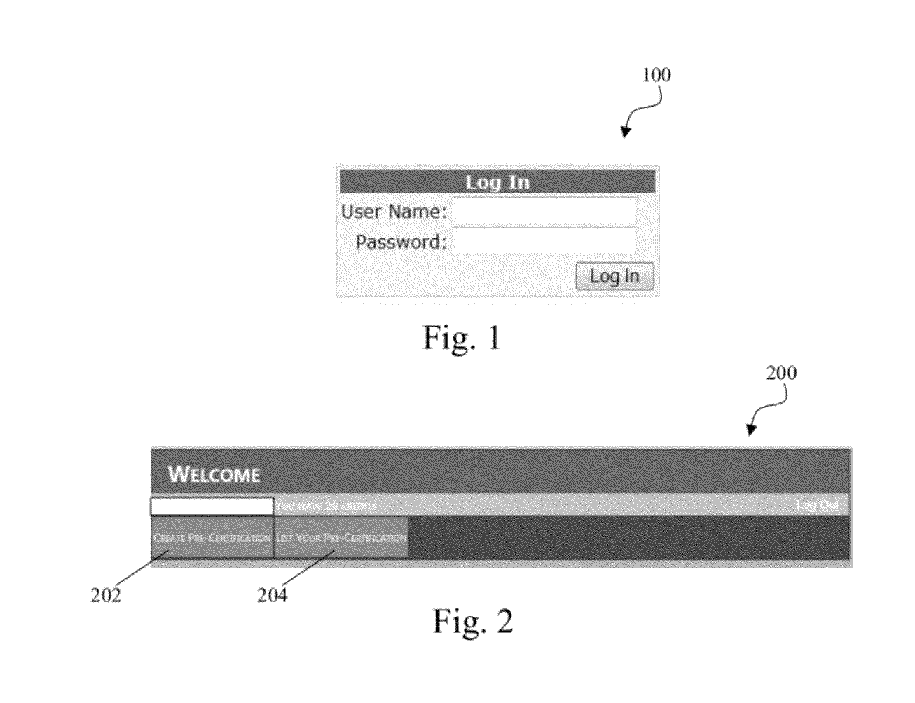

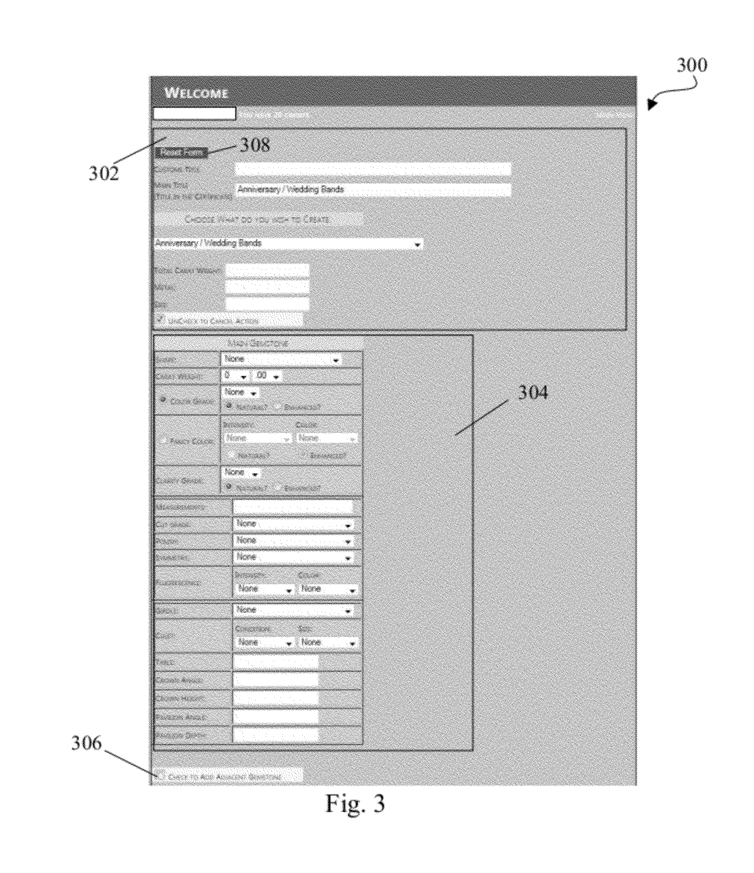

Referring now to the drawings, in which like reference numerals refer to like elements, the pre-certificate program in accordance with the present application is preferably provided via a suitable web-based environment. The program is accessible by computers operating web browser software applications, as well as mobile devices and smart-phones configured with Internet and web site accessibility. Preferably, secured access to one or more Internet web servers is provided for authorized merchants, such as by supplying user names and passwords in log-in display screen 100 illustrated in FIG. 1. Once logged-in, a merchant (or other party operating a computing device to act on behalf of a merchant, collectively referred to herein as a “merchant”) is provided with options for creating or accessing gemstone pre-certificates, such as shown in FIG. 2. Data entry and access options, including new pre-certificate hyperlink 202 for creating a new pre-certificate, and list pre-certificates hyperlink 204 listing the merchant's existing pre-certificates, are preferably provided such as in display screen 200. Other information may be provided in display screen 200, such as an indication of the number of available credits a merchant has, as well as a link to log out of the system.

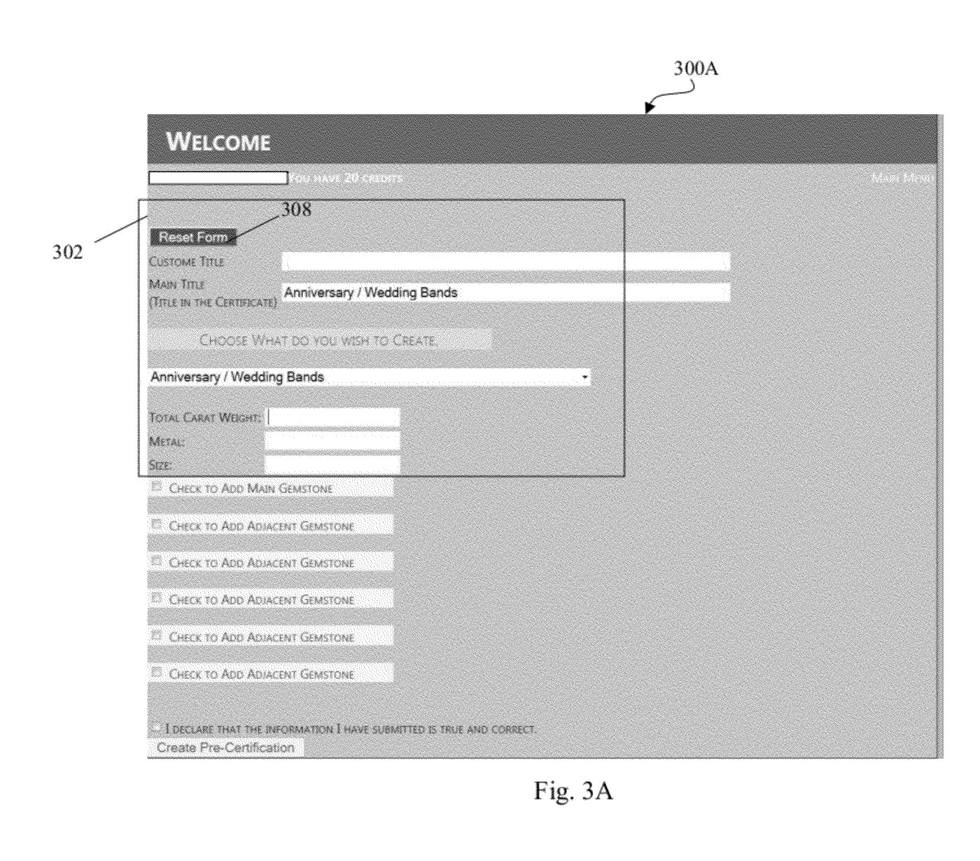

FIG. 3 illustrates example display screen 300 that is provided when a merchant selects new pre-certificate hyperlink 202 (FIG. 2) and illustrates example data entry options for ordering a new gemstone pre-certificate. In the example shown in FIG. 3, options 302 are provided for the merchant to submit information for a custom title, a main title in the certificate, and a drop-down selectable list for selecting a jewelry criteria, and text entry controls for total weight, metal and size. In the example shown in FIG. 3, the identified jewelry criteria is Anniversary/Wedding Bands.

Continuing with reference to FIG. 3, data entry options section 304 is provided for the merchant to submit information about the main gemstone for the selected jewelry criteria. For example, options are provided for the gemstone's shape, weight, color grade, fancy color and clarity grade. Other options and controls are provided for a merchant to submit information regarding measurements, cut grade, polish, symmetry, and fluorescence. Additionally, options are provided in display screen 300 for the merchant to submit information representing the cut of the gemstone, such as girdle, culet, table, crown angle, crown height, pavilion angle and pavilion depth.

In addition to the main gemstone, one or more check to add adjacent gemstone controls 306 are provided for the merchant to submit information associated with adjacent gemstones that may be provided with the selected jewelry (e.g., anniversary/wedding band). By providing data entry controls for adjacent (or additional) gemstones, merchants are able to order pre-certificates for a plethora of jewelry in virtually countless configurations.

Moreover, reset form screen control 308 is provided in case the merchant decides to erase any previously submitted data therein and start the process again.

In a preferred embodiment, once a merchant submits information for a pre-certificate, the merchant cannot modify any of the information therein. In an embodiment, any merchant desiring to alter a pre-certificate must contact a proprietor of the website in order to make any alterations or create a new pre-certificate. This decreases a likelihood that a gemstone that is sold or otherwise has an actual, final certificate generated from attempting to reproduce a more accurate pre-certificate and avoid one or more penalties, such as described herein and including having membership revoked. This further increases the integrity and accuracy of the present application.

In one or more embodiments, an abridged view or version of display screen 300 may be provided to a user that hides from view or eliminates data entry options. FIG. 3A shows an example display screen 300A that illustrates data entry options section 304 of FIG. 3 eliminated there-from.

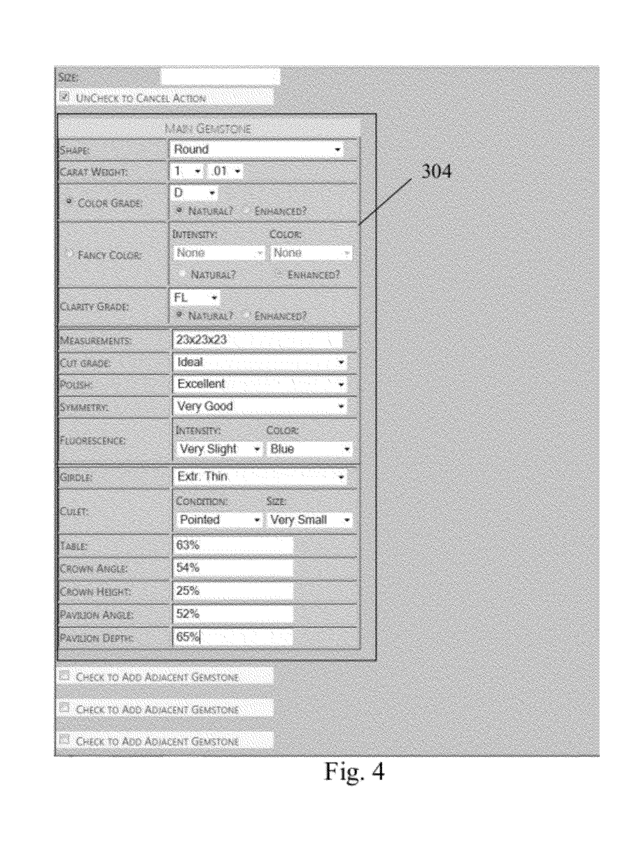

FIG. 4 illustrates data entry options section 304 (FIG. 3) with information for many of the data elements having been submitted by the merchant. In the example shown in FIG. 4, the merchant identified, among other data, a round cut, 1.01 carat, D color, with FL (natural) clarity, with an ideal cut grade, excellent polish and very good symmetry. The information is received via display screen 300, and used to generate a pre-certificate for the merchant.

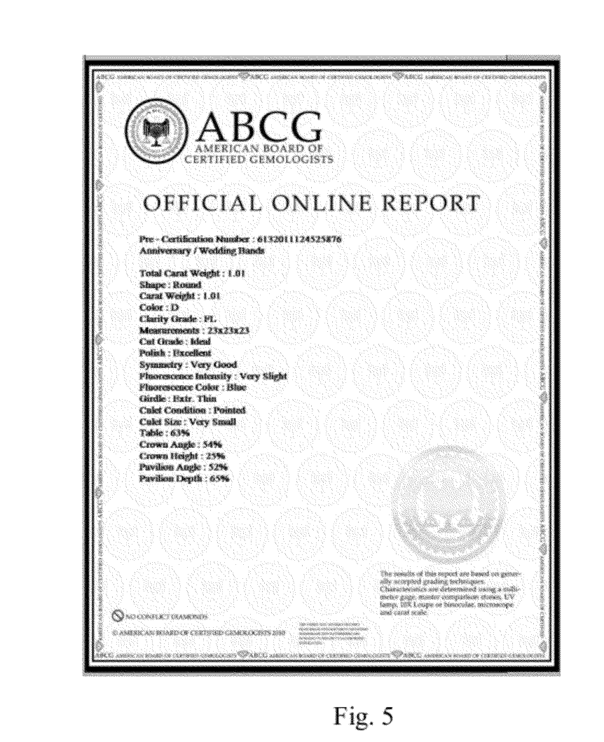

FIG. 5 illustrates an example gemstone pre-certificate 600 generated and displayed in accordance with the teachings herein. The information in pre-certificate 600 is the same as that shown and provided by a merchant in FIG. 4. Once generated, pre-certificate 600 is accessible electronically, such as via a merchant's web site or on a web site provided of a proprietor of the present application, e.g., by selecting list pre-certificates hyperlink 204 (FIG. 2). In an embodiment, a merchant's web site illustrates gemstones that are offered for sale. Interested buyers may select an option to view corresponding pre-certificates for the gemstones. Merchants can view pre-certificates generated for respective gemstones, such as via list pre-certificates hyperlink 204.

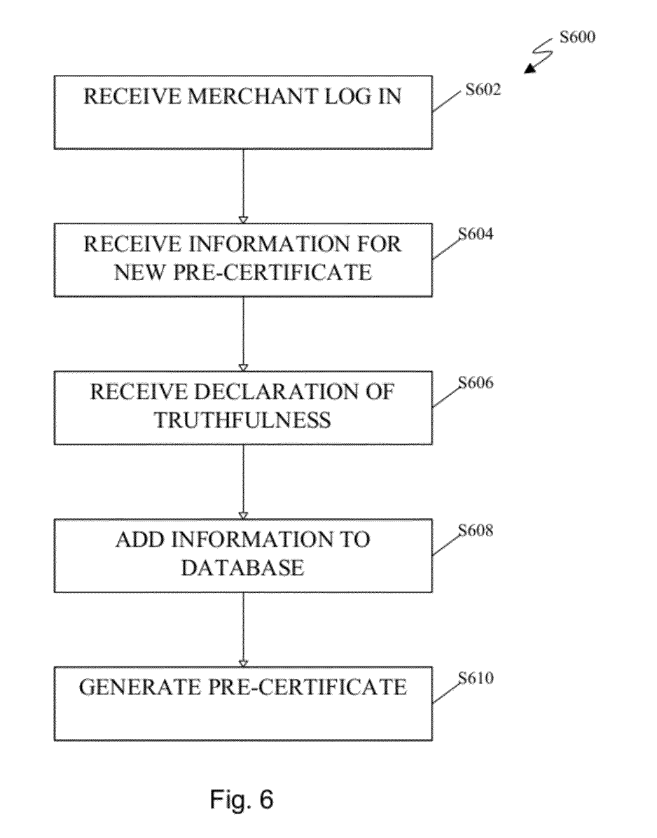

FIG. 6 is a flowchart illustrating steps 5600 associated with generating a gemstone pre-certificate in accordance with an embodiment. At 5602, a registered merchant logs in a secured Internet web site, such as by submitting an authorized user name and password. Thereafter, the merchant selects hyperlink 202 to access display screen 300 and submit information and generate a new gemstone pre-certificate (step S604). The merchant submits information associated with the respective gemstone in display screen 300 and, thereafter, selects an option declaring that all of the information submitted therein is truthful (step S606). After the declaration is received, the information submitted by the merchant is added to a database associated with the gemstone pre-certificate program (step S608). The information submitted by the merchant is used, thereafter, to generate a respective gemstone pre-certificate, such as shown in FIG. 5 (step S610). Thereafter, the process ends.

As noted above, merchants are preferably provided with gemstone pre-certificates at no additional cost and, in accordance with terms and conditions for participating in the pre-certificate program of the present application, agree to order formal gemstone certificates from the proprietor of the present application, or a gemologist designated thereby. Once a buyer expresses interest in (or purchases) a gemstone, a formal gemstone certificate is ordered.

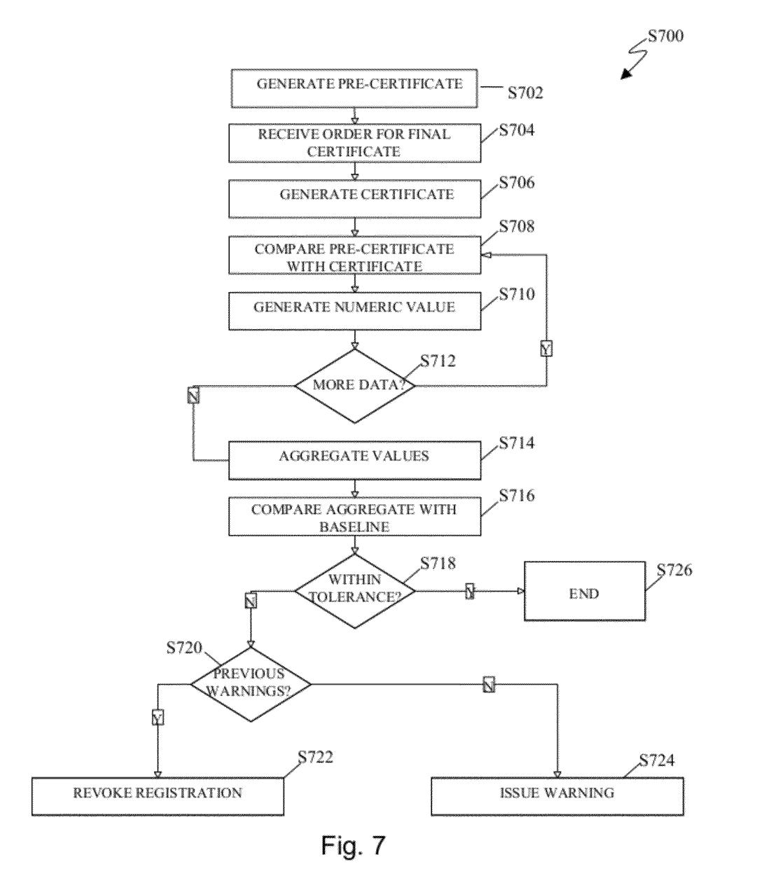

FIG. 7 illustrates an example flowchart that includes steps 5700 associated with determining the accuracy of a respective gemstone pre-certificate and reliability of a merchant. At step 5702, a pre-certificate for a respective gemstone is generated and made available for display, such as shown and described with reference to FIG. 7. Thereafter, a consumer purchases the gemstone from the merchant, and an order for a formal gemstone certificate is received from the merchant (step S704). The gemstone is physically received and a formal gemstone certificate is provided (step S706). Thereafter, a comparison is made of information associated with the gemstone pre-certificate with information in the formal certificate (step S708). During the comparison, numeric values are provided for each of the respective entries that represent the difference between the value of the entry listed on the final certificate and the corresponding entry listed in the pre-certificate. 5710, for example, a comparison is made of the first entry in the final certificate and the corresponding entry in the pre-certificate. The comparison is used to generate a numeric value representing the difference (steps S712). Thereafter, determination is made whether another data entry value as set forth in the final certificate has not been compared with the corresponding value in the pre-certificate (step S714). If so, then the process loops back to step 5710. If not, then the process continues to step 5716 and an aggregate value is determined based on the values generated by the comparisons of the respective data entry values (step S718). Thereafter a comparison is made of the aggregate value generated in step S718 with a baseline value (step S720).

Continuing with reference to the flowchart in FIG. 7, a comparison is made to determine whether the information submitted by the merchant to generate the gemstone pre-certificate is accurate within acceptable range and based on the baseline value. Thereafter, a determination is made whether the comparison yielded a value that is acceptable, i.e., within the range of acceptability (step S722). If not, then the process branches to step 5724 and the merchant is notified that the pre-certificate values are outside of an acceptable tolerance range. A further determination is made at step 5726 whether the merchant has previously been warned. If so, then the merchant is terminated from the program, and is no longer able to participate in generating pre-certificates for gemstones. If, on the other hand, the determination at step S726 is that the merchant has not been previously warned, then an initial warning is generated and transmitted to the merchant (step S728). If, on the other hand, the determination at step 5722 that the pre-certificate values were in an acceptable range of tolerance, then notification of the completion of the final certificate is transmitted to the merchant, and the process ends.

Thus and as shown in FIG. 7, the teachings herein provide for a way to ensure that accurate pre-certificates are generated and can be relied upon by consumers. Of course, one skilled in the art will recognize that the minor variations in step 5700 of FIG. 7 are envisioned such as increasing the number of warnings that may be transmitted to a merchant prior to revoking registration, or providing less severe warnings in the event that a merchant underestimates the quality of a gemstone as opposed to overestimates the quality of a gemstone.

The present application provides a new and beneficial way for merchants to offer gemstones for sale and provide assurances to buyers of respective gemstone quality. Merchants can save significant amounts of money by not having to purchase expensive final certificates prior to a buyer expressing interest in purchasing a gemstone. Whether a gemstone is mounted or otherwise, and regardless whether adjacent stones may be incorporated into a piece of jewelry, pre-certificate criteria are submitted by merchants and used to generate pre-certificates that buyers can rely on for accuracy. This enables merchants to advertise a larger inventory, which benefits buyers in their overall selections, and reduces costs for merchants. Moreover, since the process shown and described herein is largely unsupervised, particularly during the initial pre-certification stages, a large volume of gemstones and merchants can be serviced, thereby further increasing the overall inventory of available gemstones for sale and decreasing associated costs thereof.

Moreover, the proprietor of the teachings herein, such as a website operator or a host, can financially benefit from the present application, for example, by receiving contractual assurances that merchants will order final gemstone certificates from the proprietor. Other sources of revenue are envisioned herein, such as fees that may be charged to merchants for initial registration. Moreover, advertising revenue may be earned. In an embodiment, a percentage of the price of each gemstone sold that has a pre-certificate generated in accordance with the present application may be earned as well.

Since merchants advised that entries that are submitted during the pre-certificate process may be analyzed and compared to values set forth in an actual final gemstone certificate, merchants are motivated to be accurate and perhaps even conservatively estimate the quality of respective gemstones.

Moreover, and as shown and described above, images of gemstone pre-certificates are instantly made available and useful, for example, via merchant websites, to show to buyers. The present application builds a trust between merchants and buyers and further precludes merchants from having to pay for expensive final certificates unless a gemstone is sold.

Although the present application is described and shown in relation to particular embodiments thereof, many other variations and modifications and other uses will become apparent to those skilled in the art. Thus, various embodiments and variations are shown and described herein, and it is preferred, therefore, that the present application be limited not by the specific disclosure herein.

What is claimed is:

1. A method for providing authentication information associated with a gemstone, the method comprising:
storing, on one or more processor readable media that are operatively coupled to one or more processors, at least one database comprising:
i) electronic gemstone information received from a plurality of merchants and including information representing a plurality of respective gemstones;
ii) electronic certificate information representing certificates of at least some of the plurality of respective gemstones;
receiving, by the one or more processors from a first computing device operated by a first merchant over a communication network, first electronic gemstone information representing a first determination of at least one characteristic of a first gemstone;
generating, by the one or more processors using at least some of the first electronic gemstone information, a pre-certificate that represents at least some of the characteristics of the gemstone;
providing, to the first computing device, the pre-certificate;
receiving, by the one or more processors, second electronic gemstone information associated with a final certificate that represents a second determination of the at least one characteristic of the gemstone;
determining an accuracy of the first determination by comparing the second determination with the first determination; and
transmitting a notification to the first computing device representing the accuracy.

2. The method of claim 1, wherein the determining the accuracy comprises assigning a value representing a difference between the second determination and the first determination.

3. The method of claim 1, further comprising registering the first merchant, wherein the registering comprises charging a fee to the first user.

4. The method of claim 3, wherein the transmitting the notification occurs only when the accuracy is below a predetermined threshold.

5. The method of claim 4, wherein the notification is a warning that the accuracy is below the predetermined threshold.

6. The method of claim 4, further comprising revoking first merchant's registration when the accuracy is below the predetermined threshold.

7. The method of claim 1, further comprising receiving from the first computing device a declaration that the first electronic gemstone information is truthful.

8. The method of claim 1, further comprising providing the pre-certificate to the first merchant at no additional cost.

9. The method of claim 1, wherein the first electronic gemstone information is received in an Internet web site and in response to at least one prompt.

10. The method of claim 1, wherein the first electronic gemstone information represents at least one of shape, weight, color grade, fancy color, clarity grade, cut grade, polish, symmetry, fluorescence, girdle, culet, table, crown angle, crown height, pavilion angle and pavilion depth.
